(19) United States
(12) Patent Application Publication
(10) Pub. No.: US 2014/0014785 A1
(43) Pub. Date: Jan. 16, 2014

(54) ORGANISER

(71) Applicant: Peter Lee, Southend-on-Sea (GB)

(72) Inventor: Peter Lee, Southend-on-Sea (GB)

(21) Appl. No.: 14/005,647

(22) PCT Filed: Mar. 19, 2012
(86) PCT No.: PCT/GB12/50594

§ 371 Date: Sep. 17, 2013

(30) Foreign Application Priority Data
Mar. 17, 2011 (GB) 1104526.7

(51) Int. Cl. F16L 3/00

(52) U.S. Cl. CPC F16L 3/00
USPC 248/49

(57) ABSTRACT

An organiser for an electrical plug and cable extending away from the plug includes a body having a first surface and a three-dimensional second surface. The first surface includes a plurality of openings for receiving the pins of a plug, the openings arranged to permit the reception of the pins of more than one standard plug type. The second surface is configured to allow the cable to be wound therearound and retaining means is provided for holding the cable in its wound condition.

This invention relates to an organiser for an electrical plug and associated cable, to assist use and storage of the plug and cable in an organised, tidy and tangle-free manner.

The invention typically concerns (but is not limited to) low power applications such as cables and plugs to power mobile phones or cameras, rather than mains cables which may carry up to 13 Amps. While a particular emphasis has been placed on such low power applications, it will be appreciated that the organiser may be used for mains cables if appropriately configured for this purpose.

External power connectors are used to provide a connection between a power source and a device requiring the supply of power. External power connectors generally comprise a cable and an electrical plug from which the cable extends, the end of the cable remote from the plug having a connector adapted to mate with an input port of the device to be powered. Often, the plug comprises a part of a transformer, a switch mode power supply or the like. When the device does not require the supply of power the power connector is usually disconnected from the device and stored. The cable of a power connector can become tangled when stored, particularly if more than one power connector is stored in the same place. In an attempt to minimise tangling of the cable, many people wind the cable around the body or pins of the plug. This can cause stress on the cable and as the cable is not securely held, it is likely to come free and result in tangling.

Cable tidy devices are known, but these are not usually designed to hold a plug provided at one end of the cable. With advances in technology there are many different types of power connector plugs, for example mains plugs, USB plugs and vehicle auxiliary plugs. Even with mains plugs, the size, shape and arrangement of pins vary from country to country.

It is a principal aim of the present invention to provide a plug and cable organiser which can be used with several different types of plugs, to organise plug and cable storage in a tidy fashion and which addresses the problems discussed above.

According to this invention, there is provided an organiser for an electrical plug and cable extending away from the plug, the organiser comprising a body providing a first surface having a plurality of openings for receiving the pins of a plug, the arrangement of the openings permitting the reception of the pins of more than one standard plug type, the body also providing a three-dimensional second surface configured to permit the winding of the cable therearound, there being retaining means for holding the cable in its wound condition around the second surface.

It will be appreciated that the first surface is essentially a two-dimensional flat surface having the openings formed therein whereas the second surface is three-dimensional and configured for the winding of a cable therearound. Preferably the openings are intermingled within the same area on the first surface and are arranged so that the pins of only a single plug may be received in the openings of the organiser at any one time. The openings in the first surface may be configured to receive the pins of a range of different plug types, including for example the three pins of a British Standard type plug, the two pins of a typical U.S. style plug and the two pins of a conventional European type plug. Openings may be provided to receive a variety of other plug types not mentioned herein and such an arrangement will fall within the scope of this invention.

In one embodiment the retaining means comprises a bar arranged for movement between a cable retaining position and a non-retaining position. This may be achieved by pivotally mounting the bar to the body for rotation between the retaining and non-retaining positions. Preferably though, the bar is mounted in a carrier for sliding movement within the carrier between the cable-retaining and non-retaining positions. In this way, the carrier serves as a guide for the sliding movement of the retaining bar.

The retaining means may further comprise a flange extending around the second surface at or adjacent an end thereof, and the flange assisting retention on the second surface of a cable wound threrearound. In an embodiment where the flange is arranged at an axial end of the second surface, the first surface may be disposed at the other end of the second surface to lie in a plane substantially orthogonal to the axis of the second surface. The flange may extend continuously around the second surface or may comprise a series of distinct projections arranged to retain the cable on the second surface.

In a preferred arrangement, the carrier is provided on the flange. The flange projects beyond the second surface of the organiser and thus the carrier can be located so that the retaining bar is spaced from the second surface. The spacing should be sufficient to allow accommodation of a cable wound on the second surface.

Preferably the body is of substantially triangular prismatic form having two opposed essentially triangular end faces, and wherein the first surface is defined by one of the end faces. This shape facilitates the provision of a wide range of openings to receive the pins of a divers range of plug types while minimising the amount of material used to form the organiser. The second surface is formed between the end faces and comprises three side faces. It is beneficial that the transition between each pair of adjacent side faces is rounded to provide a smooth second surface. By eliminating any sharp edges at the transitions the likelihood of damage to the cable is reduced.

To provide additional versatility the organiser may also comprise a receptor for electrical plugs which do not have projecting pins, such as a one of the several conventional types of USB plugs or vehicle auxiliary plugs. The receptor may include an engagement member preferably in the form of a bar receivable in one of the openings in the first surface thereby to retain the receptor to the body. Preferably means are provided to resist removal of the receptor once engaged with the first surface. For example, a peg may project laterally from the engagement member so that when the engagement member is located in an opening and the receptor is turned, the peg engages behind the first surface. A groove may be formed in the body to receive the peg when the receptor has been turned, so as to restrain accidental release of the receptor. The groove serves to hold the peg in a retaining position so that a greater turning force is required to release the receptor.

A stop may be provided on the body to limit rotation of the receptor relative thereto when the peg is in the groove. Ideally the groove is provided adjacent the stop so that the peg is guided into the groove simply by turning the receptor until the peg reaches the stop. Two stops may be provided and a groove formed in the body adjacent each stop.

The receptor may further comprise a lip extending laterally therefrom. There may be two positions for the lip relative to the body. In a first position the lip is aligned with the retaining means and co-operates therewith to retain a cable wound around the second surface. In a second position the lip is not aligned with the retaining means and does not retain a cable on the second surface. The two positions of the lip preferably correspond to the engagement of the peg in each of the two grooves.

The organiser may be configured so that for at least some plug types, when the plug is received in the organiser, or in the receptor if used, the plug has portions which extend beyond the second surface to co-operate with the retaining bar in order to maintain the cable wound around the second surface.

It may be useful for certain applications for the organiser to be provided with additional cable fastening means. This may particularly beneficial for electrical plugs having mains cables where the cable is too large to be secured by the cable retaining means. In such arrangement, the cable may further comprise a cable fastener arranged on the body and configured to hold a cable of an electrical plug received in the organiser and formed into a hank. The cable fastener is preferably a strap having end portions configured for securing together around a cable to be fastened. The securing of the cable may be achieved by hook and look fasteners provided on each end portion of the strap or some other releasable securing means. More preferably though, the strap end portions comprise a plurality of prongs and openings, each prong being configured releasably to secure into an opening.

An organiser of this invention is preferably mounded from a plastics material. The body of the organiser may be hollow. The organiser may come in a variety of different colours so that different received plugs can be easily recognisable and distinguishable. A range of different sized organisers may also be provided for plugs having a variety of cable lengths and thicknesses.

The organiser of this invention provides a neat, tidy, tangle-free solution to the storage problem of plugs and cables and is versatile as it is suitable for a wide range of plug types and cable lengths. The organiser may also be used to reduce the length of a cable when the plug is being used to power a device. The organiser is simple and quick to use. A plug and cable may be removed from the organiser by simply pulling the plug and cable from one end of the body, without the need to unwind the cable from the second surface.

By way of example only, one specific embodiment of organiser of this invention will now be described in detail, reference being made to the accompanying drawings in which:

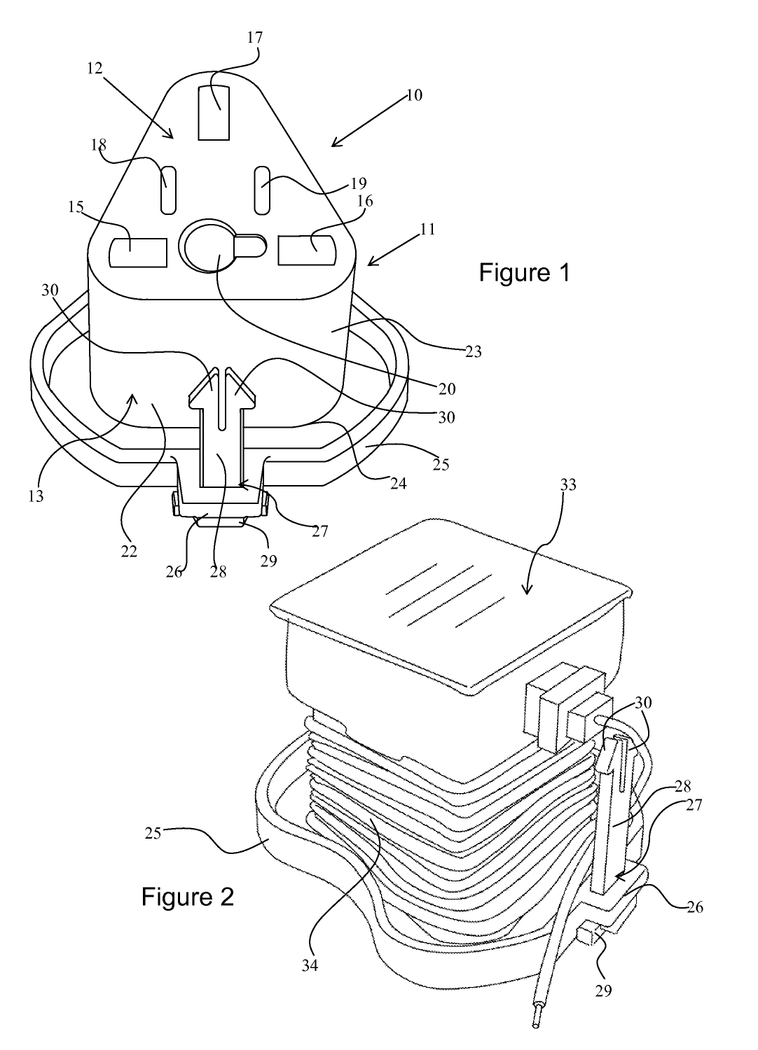

FIG. 1 is a perspective front view of the organiser of the present invention;

FIG. 2 is a perspective view of a plug and cable organised with the organiser of FIG. 1;

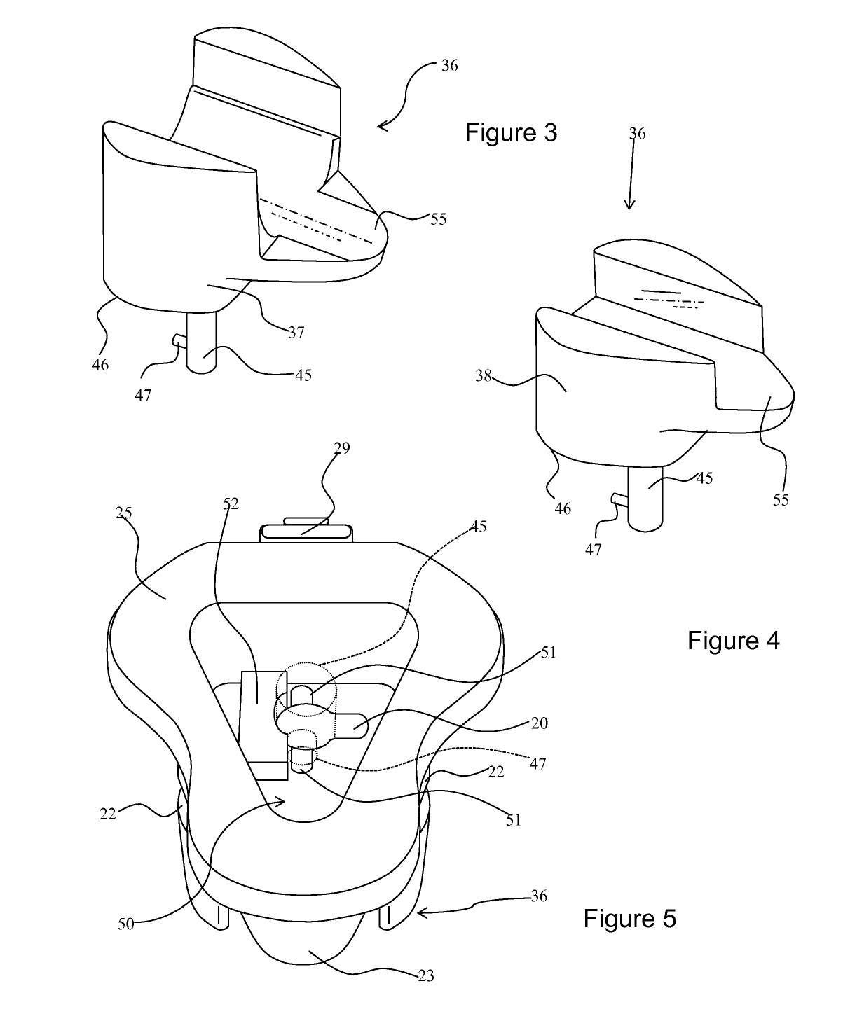

FIG. 3 is a perspective view of a first receptor for connection to the organiser of FIG. 1;

FIG. 4 is a perspective view of a second receptor for connection to the organiser of FIG. 1;

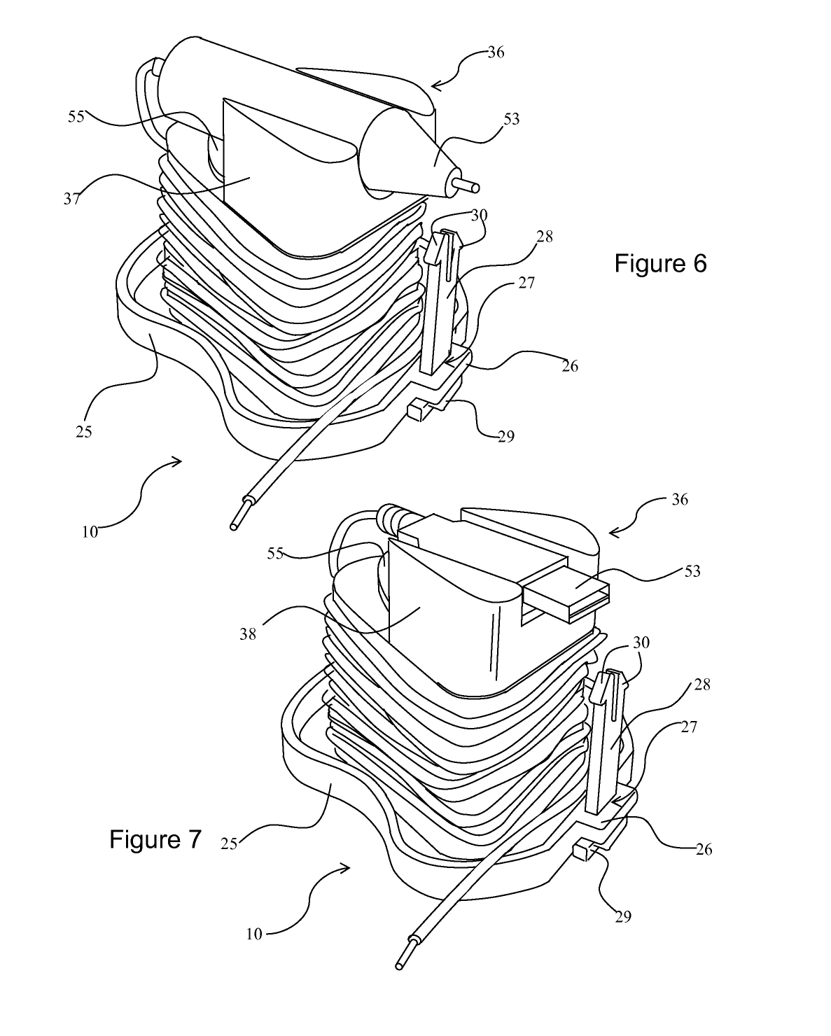

FIG. 5 is a perspective view of the receiving arrangement between the organiser and the receptors of FIGS. 3 and 4;

FIG. 6 is a perspective view of a plug and cable organised with the organiser and receptor of FIG. 3;

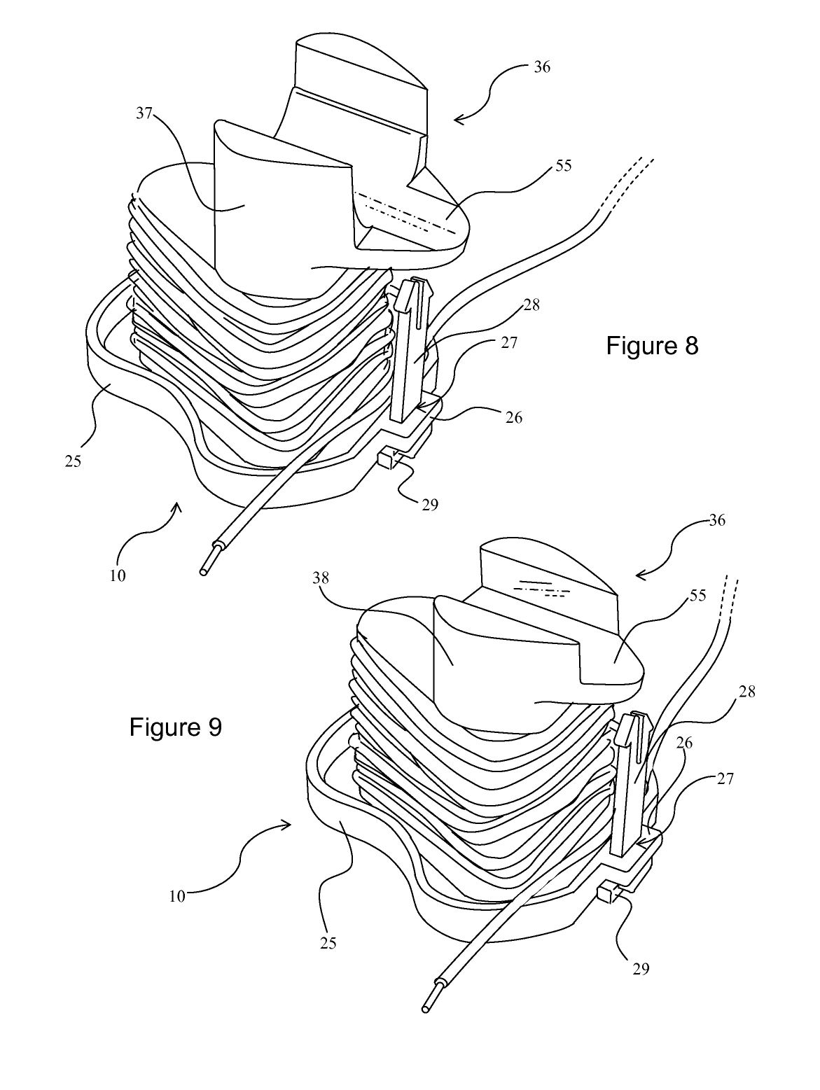

FIG. 7 is a perspective view of a plug and cable organised with the organiser and receptor of FIG. 4;

FIG. 8 is a perspective view of a cable organised with the organiser and receptor of FIG. 3;

FIG. 9 is a perspective view of a cable organised with the organiser and receptor of FIG. 4;

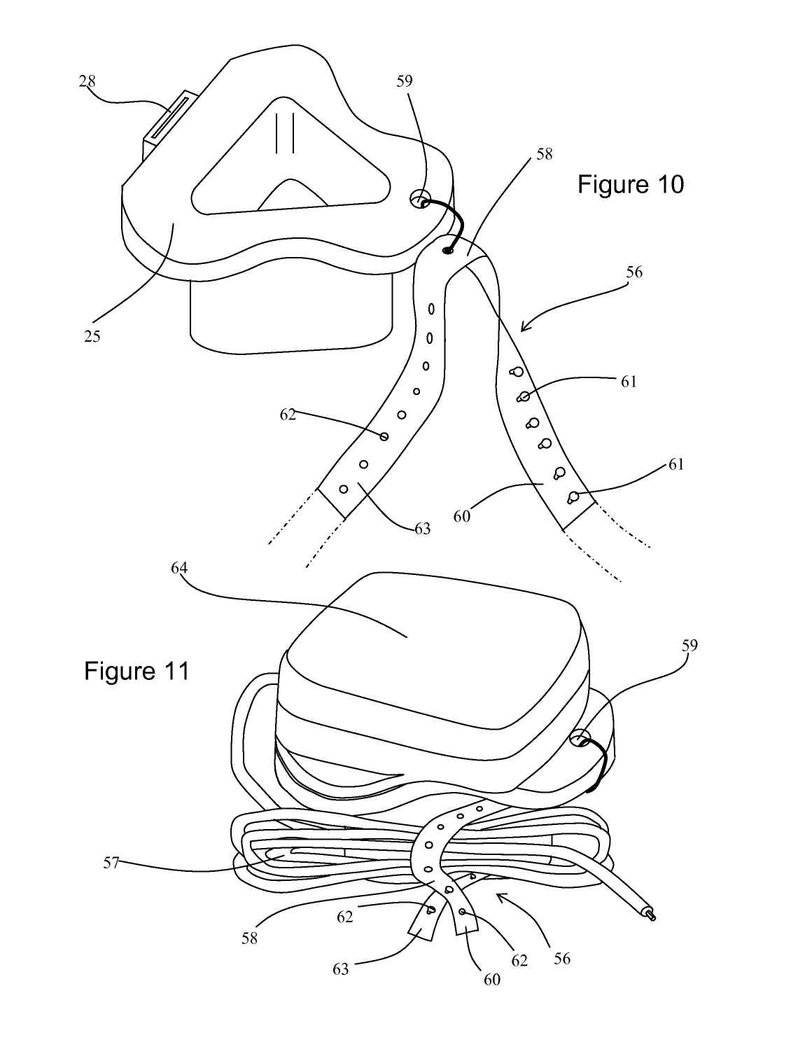

FIG. 10 is a perspective view of the organiser having a cable fastener; and

FIG. 11 is a perspective view of a cable organised with the cable fastener of the organiser of FIG. 10.

Referring to the drawings, there is shown an organiser 10 which comprises a body generally in the form of a hollow triangular prism 11. The prism 11 is defined by a generally triangular first surface 12 and a three-dimensional second surface 13.

A plurality of openings 15, 16, 17, 18, 19, 20 are formed through the first surface 12 for receiving the pins of an electrical plug. The openings 15, 16, 17, 18, 19, 20 are located and configured to enable more than one plug type to be received by the organiser 10. A first set of openings 15, 16, 17 are provided to receive the three pins of a conventional British Standard plug type. Two of those same openings 15, 16 are configured also to receive the two pins of a typical U.S. type plug. A second set of openings 18, 19 are provided for the two pins of a European style plug. Also provided in the first surface is a keyhole shaped opening 20 which is designed for the connection of a receptor 36, described in more detail below.

The second surface 13 is defined by three side faces 22 lying at 120° to each other and extending orthogonally from the first surface 12. The side faces 22 have rounded corners 23 between each adjacent pairs of side faces 22. The rounded corners 23 minimise the likelihood of damage to a cable wound around the second surface, which could otherwise be caused by sharp corners.

A cable retaining flange 25 extends around the axial end 24 of the second surface. The flange 25 includes a carrier 26 which has a rectangular aperture 27. A retaining bar 28 is slidably movable within the aperture 27 between cable retaining and non-retaining positions. The retaining bar 28 is a close-sliding fit in the aperture 27 and has one end 29 which is T-shaped to prevent removal from the carrier 26. The other end is bifurcated to provide two arms 30 each having a barb 31 allowing the bar 28 to be selectively inserted or removed.

FIG. 2 shows the organiser 10 in use with a conventional British Standard plug 33 having a cable 34. To achieve this arrangement, a user first inserts the pins of the plug 33 into the corresponding openings 15, 16, 17 provided in the first surface 12. To provide access to the second surface 13 for the cable 34 associated with the plug 33 to be wound around, the retaining bar 28 should be in the non-retaining position. The cable 34 may then be wound around the second surface 13 of the organiser 10 in a tidy fashion. Next, the retaining bar 28 is moved to the retaining position whereby the cable 34 is held between the retaining bar 28 and the second surface 13. The flange 25, in conjunction with the retaining bar 28 retains the cable 34 on the second surface 13. When organised in this way, the plug 33 co-operates with the retaining bar 28 to maintain the cable 34 wound around the second surface 13. The cable 34 and plug 33 may be removed from the organiser 10 by sliding the retaining bar 28 to the non-retaining position and then pulling both the cable and plug from the organiser 10, in a direction parallel to the axis of the second surface 13.

The type of electrical plug and cable which may be stored and/or held using the organiser 10 of this invention is not limited to plug types having projecting pins. To provide additional versatility a receptor 36 is provided to allow electrical plugs which do not have projecting pins to be used with the organiser 10. The plug cable may be wound around the second surface 13 of the body 11 in the same way as described above.

FIGS. 3 and 4 show two types of receptor 37, 38, each having a receiving area for an electrical plug, such as a vehicle auxiliary plug or a USB plug. In the case of receptor 37 the receiving area is generally curved for receiving cylindrical shaped vehicle auxiliary plug. The receiving area of receptor 38 is generally rectangular to receive a rectangular shaped USB plug. Other than the receiving areas, the auxiliary and USB receptors 37, 38 are essentially the same.

The receptor 36 includes a cylindrical engagement member 45 extending from the rear end 46 for connection to the body 11. A peg 47 extends laterally from the engagement member 45 and serves to retain the receptor 36 to the body 11, by engaging a retaining surface 50 provided on the opposing side face of the first surface 12. The keyhole shaped opening 20 is shaped to allow the engagement member 45 and peg 47 to pass therethrough and then be rotated relative to the body 11.

The retaining surface 50 includes two grooves 51 corresponding to two retaining positions and into which the peg 47 is engagable. A stop 52 is provided on the retaining surface 50 adjacent each groove 51 and serves to limit rotation of the receptor 36 relative to the body 11. As shown in FIGS. 6 and 7, the receptor 36 is configured so that a plug held in the receiving area 39, 41 extends partially beyond the second surface 13. The extending part 53 co-operates with the retaining bar 28 to maintain a wound cable, associated with the plug, on the second surface 13.

A lip 55 is provided on the receptor 36 and co-operates with the retaining bar 28 to ensure that a wound cable is maintained around the second surface 13 when a plug is not received in the openings. The lip 55 may extend from the rear end 46 of the receptor 36 or may be spaced from the rear end 46 as shown in FIGS. 3 and 4 to provide an extension for the second surface 13 and around which the cable may also be wound.

FIGS. 6 and 7 show the organiser 10 being used as both a plug and cable organiser. In each case, to organise the plug and cable, a receptor 36 is first secured to the body 11 by passing the engagement member 45 and peg 47 through the keyhole shaped opening 20 in the first surface 12. The receptor 36 is then rotated relative to the body 11 to secure the receptor 36 in a first retaining position, where the peg 47 is engaged in a first groove 51 and the lip 55 is not aligned with the retaining bar 28. Next, the user must insert the plug into the receiving area of the receptor 36 and then ensure that the retaining bar 28 is in a non-retaining position. The cable may then be wound around the second surface 13 of the organiser 10 in a tidy fashion and the retaining bar 28 moved to the retaining position whereby the cable is held between the retaining bar 28 and the second surface 13. In both of the arrangements shown in FIGS. 6 and 7, the cable and plug may be removed from the organiser 10 by simply pulling the cable and plug away from the receptor 36.

In FIGS. 8 and 9, the plug has been removed and the organiser 10 is being used solely as a cable organiser. In this arrangement, to ensure that the cable is maintained around the second surface 13 after removal of the plug, the receptor 36 should be rotated relative to the body 11 so that the peg 47 engages with the second groove 51 in a second retaining position where the lip 55 of the receptor 36 is aligned with the retaining bar 28. The lip 55 co-operates with the retaining bar 28 to maintain the wound cable around the second surface 13.

The organiser 10 may be configured for use with a range of electrical plugs, including those having large cables, for example mains cables. Alternatively, as shown in FIGS. 10 and 11 a cable fastener 56 may be attached to the body 11 to hold cables 57 which are too large to be secured with the retaining bar 28. In this arrangement, the electrical plug 64 is received in the organiser 10. The cable fastener 56 as shown is a strap 58 arranged to secure to an opening 59 provided in the cable retaining flange 25. One end portion 60 of the strap 58 has a plurality of prongs 61 and these are configured to secure into corresponding openings 62 provided on the other end portion 63 of the strap 58. A large cable 57 may be bundled together and fastened by securing the strap 58 around the centre of the bound cable 57.

1. An organiser for an electrical plug and cable extending away from the plug, the organiser comprising a body providing a first surface having a plurality of openings for receiving the pins of a plug, the arrangement of the openings permitting the reception of the pins of more than one standard plug type, the body also providing a three-dimensional second surface configured to permit the winding of the cable therearound, there being retaining means for holding the cable in its wound condition around the second surface.

2. An organiser as claimed in claim 1, wherein the retaining means comprises a member mounted in a carrier and configured for movement between a cable-retaining position and a non-retaining position.

3. An organiser as claimed in claim 2, wherein the retaining means comprises a bar slidably mounted in the carrier for movement between the cable retaining and non-retaining positions.

4. An organiser as claimed in claim 2, wherein the retaining means further comprises a flange extending around the second surface, at or adjacent one end thereof, to assist retention on the second surface of a cable wound therearound,

5. An organiser as claimed in claim 4, wherein the carrier of the retaining means is provided on the flange,

6. An organiser as claimed in claim 1, wherein the body is of a substantially triangular prismatic form having two opposed substantially triangular end faces, and wherein the first surface is defined by one of the substantially triangular end faces.

7. An organiser as claimed in claim 6, wherein the second surface is formed between the end faces and comprises three side faces configured so that the transition between each pair of adjacent side faces is rounded to provide a smooth second surface.

8. An organiser as claimed in claim 1, wherein the organiser further comprises a receptor selectively attachable to the body, the receptor being configured to receive an electrical plug having a cable extending away therefrom.

9. An organiser as claimed in claim 8, wherein the receptor includes an engagement member receivable in an opening in the first surface to retain the receptor to the body.

10. An organiser as claimed in claim 9, further comprising a peg projecting from the engagement member, the opening being configured to allow the peg to pass therethrough and the peg being locatable against the body by rotation of the receptor relative thereto.

11. An organiser as claimed in claim 8, wherein the receptor further comprises a lip extending therefrom and which serves to co-operate with the retaining means to retain a cable wound around the second surface.

12. An organiser as claimed in claim 8, wherein the receptor is configured to receive at least one of a USB plug and a vehicle auxiliary plug.

13. An organiser as claimed in claim 1 further comprising a cable fastener arranged on the body and configured to hold a cable of an electrical plug received in the organiser and formed into a hank.

14. An organiser as claimed in claim 13, wherein the cable fastener is a having end portions configured for securing together around a cable to be fastened.

15. An organiser as claimed in claim 14, wherein the strap end portions comprise a plurality of prongs and openings, each prong being configured releasably to secure into an opening.
